(19) United States
(12) Patent Application Publication
(10) Pub. No.: US 2009/0090038 A1
(43) Pub. Date: Apr. 9, 2009

(54) Lure retrieval systems and method

(76) Inventor: Freddie Meredith, Hot Springs, AR (US)

Correspondence Address: DENNIS B. HAASE, P.O. BOX 6206, HOT SPRINGS, AR, 71902-6206, US

(21) Appl. No.: 11/973,050

(22) Filed: Oct. 9, 2007

(51) Int. Cl. A01K 97/24

(52) U.S. Cl. 43/17.2

(57) ABSTRACT

A system for freeing a fishing lure at the end of a line where the lure has been snagged on sub surface debris, which features a retriever with a unique guide for guiding the retriever along the fishing line to impact the lure. The guide permits an exceptionally simple and fast method of attaching and detaching the guide. Additionally, the retriever may serve as a sinker.

The present invention relates generally to the sport of fishing and, more particularly, to improvements in retrieval systems for successful recovery of a lure that has been snagged on debris beneath the water.

### BACKGROUND OF THE INVENTION

1. Field of the Invention

Fishing, once a procedure for obtaining food, has evolved into a multi million dollar industry, a major facet of which is tournament competition. Tournaments, as such, are conducted by FLW, having very considerable purses, often in the six figure range.

Then there are those who simply enjoy being in a boat or along a shore line, in relative peace and quiet with a pole and a tackle box of lures, some of which are relatively expensive.

Whether in competition or simply recreating, no fisherman enjoys losing a lure, and there is a cottage industry that evolved about the recognition that fishermen are fond of their lures and do not relish leaving them in the deep. Losses, however, are often part of the sport, and lure retrieval devices are available to minimize such losses. Fish have an affinity for areas where brush, broken tree limbs and other under water debris are present, and this proclivity is well known to fishermen.

2. Overview of the Prior Art

The concept of lure retrieval is not a new concept. Indeed, it has been around as long as the problem has been recognized. It has evolved from the very early “yank on the line” philosophy to some rather complex devices, the bulk of which are of the view that the way to free a lure that has hung up on debris in the water is to hammer it loose.

An early example of the hammer concept as it is represented in the patent art is Kocarek U.S. Pat. No. 2,526,031, wherein a retriever with a tubular body, formed with a passage for the fishing line, is provided, and a separate control line is attached. The retriever, devised in 1946, is sufficiently free to slide on the fishing line that when it is released from a suitable height above a trapped lure it will slide down the line and strike the lure, hopefully freeing it. If, however, it does not, the control line is used to pull up the retriever, allowing it to drop once again, thereby repeating the process.

Similar in concept but diverse in method, Carr, in his U.S. Pat. No. 2,562,413, envisioned a releasing member guided along a fishing line while being operated by a reel.

The hammer concept is alive and well in the 2004 patent to New, U.S. Pat. No. 6,705,040, which, in the manner of Carr, the retriever, an impact body, is guided by the fishing line, but controlled separately by a tether, for repeated hammering.

Several other variations on the same theme have been offered to the fisherman over the years, among them one offered by Murray Monsters, all of which offer some success as they also increase the number of attendant problems. Sevegny U.S. Pat. No. 2,399,298 is of interest only to the extent that it offers a structure which is useable as a sinker.

### SUMMARY OF THE INVENTION

The retrieval system of the present invention, unlike its predecessors, seeks to provide the fisherman with a means of freeing a lure the first time, every time.

To this end, it is an objective of the present invention to provide a novel system for the retrieval of a fishing lure which has been snagged on a subsurface branch, tree root or other debris and to do so in a single cycle.

It is another objective of the present invention to provide a retrieval system in which the retriever is quickly and simply attached to a line, at the end of which is a snagged lure, for rapid impact with the lure, delivering a single blow sufficient to free the same. It is an objective related to the foregoing to provide a system in which the retriever is readily removed from the line, as easily as it was attached and without cutting the line, when the task of freeing the lure is accomplished.

It is yet another objective to provide a retriever which is alternatively capable of serving as a sinker when desired.

The ability of the system of the present invention to achieve the foregoing enumerated objectives, as well as others, will become apparent to those skilled in the art when the following Detailed Description of a Preferred Embodiment is read in conjunction with the description of the drawings, wherein:

### BRIEF DESCRIPTION OF THE DRAWINGS

FIG. 1 is a perspective view of a retriever constructed in accordance with the present invention and adapted to function in the retrieval system thereof;

FIG. 2 is a side elevation of the retriever of FIG. 1;

FIG. 3 is a top plan view of the retriever of FIG. 1;

FIG. 4 is an end view of the retriever of FIG. 1;

FIG. 5 is an exploded view of the system of the present invention showing the interrelationship of the retriever with a fishing line;

FIG. 6 is a view illustrating the initial step in attaching the retriever to the fishing line;

FIGS. 7, 8, 9 and 10 illustrate, sequentially, the remaining steps necessary to secure the retriever to the fishing line properly;

FIG. 11 illustrates the retriever as it descends along the fishing line toward a snagged lure; and,

FIG. 12 shows the retriever impacting the lure, freeing it from the debris upon which it is snagged.

### DETAILED DESCRIPTION OF A PREFERRED EMBODIMENT

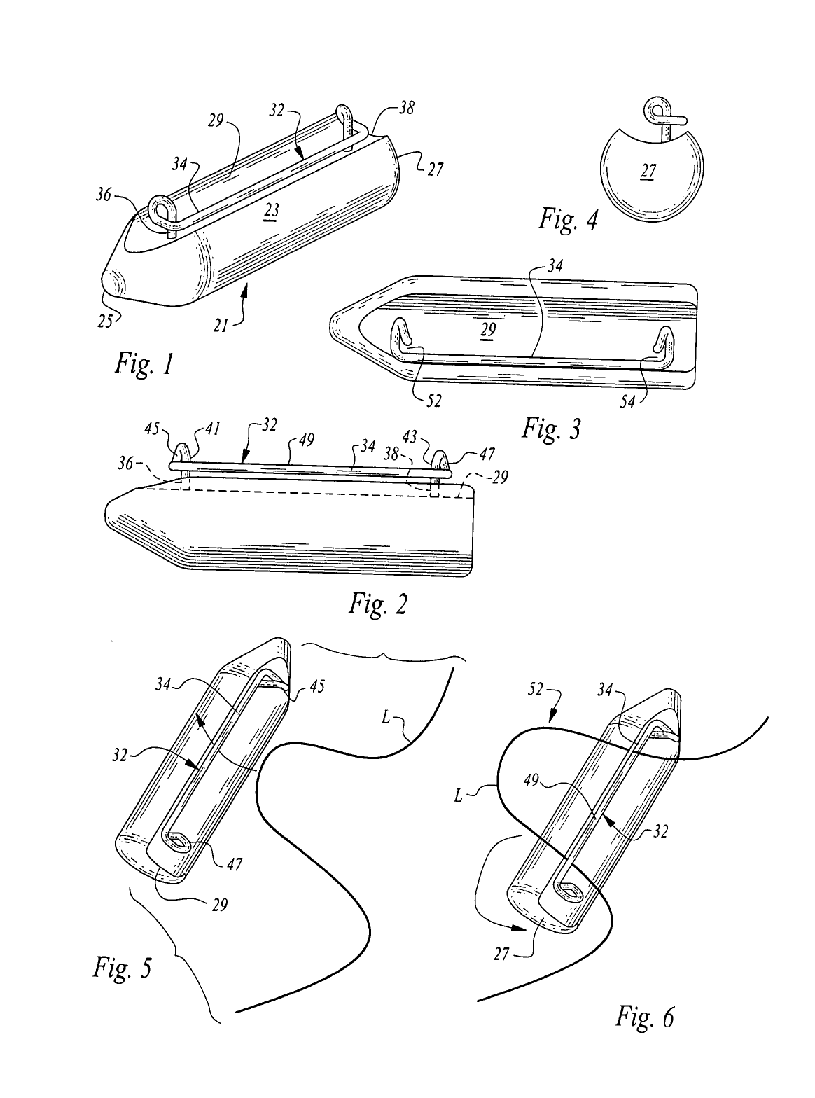

With reference now to the drawings, and initially to FIG. 1, the heart of the system is a retriever 21, and the advanced method of attachment to, and detachment from, a fishing line.

The retriever 21, in its depicted form, includes an elongated tubular body 23 having a nose 25 at one end and a butt end 27 at the opposite end. As seen in FIGS. 1, 2 and 3, a longitudinally extending trough, or depression, 29, which traverses substantially the length of the body 23, is formed therein. In a typical case, the retriever is approximately 1½ to 2 inches long and weighs approximately 1 to 3 ounces. In order to be able to provide a retriever of sufficiently small size, a relatively high density material is preferred. Thus, the retriever is easily fitted in a tackle box, or even one's pocket when not in use.

A retriever guide 32 is secured to the body 23 in the trough 29. The retriever guide is a key to the accomplishment of the objectives of the system in that it facilitates attachment and removal of the retriever to a fishing line L, and guides it, unimpeded, toward the imperiled lure F, impaled on some sub surface debris such as a branch B.

The retriever guide, in its illustrate form, comprises a unitary wire 34 of suitable strength, yet flexible enough to be bent into the configuration as seen in the drawings. Referring specifically to FIGS. 1 through 5, the guide 32 is comprised of the wire 34, having remote ends 36, 38 which are secured, in any one of several well known ways, in the retriever 21. Each end forms an upstanding post 41, 43 at the apex of which, the wire bends outwardly of its companion post, slanted toward its nearest end of the retriever, defining loops 45, 47. The loops terminate in a cross bar 49 extending longitudinally between them and beneath the apex of the posts. It will be observed that there is a small space 52, 54 [best seen in FIG. 3] between each of the posts 41, 43 and the cross bar 49.

One of the unique features of the guide 32 is the rapidity and simplicity with which the retriever is pressed into service when needed.

FIGS. 6 through 10 graphically illustrate the stark simplicity of the task of loading the retriever on a fishing line L, when needed. Beginning with FIG. 6, and with the fisherman's lure F snagged on some sub surface debris B, it is determined that the best way to free the lure is to hit it with a retriever. The fisherman forms a curl, or curve, 52 in the fishing line L as seen in FIG. 6, and the curl is slid through the space between the retriever 21 and the crossbar 49 of the guide 32.

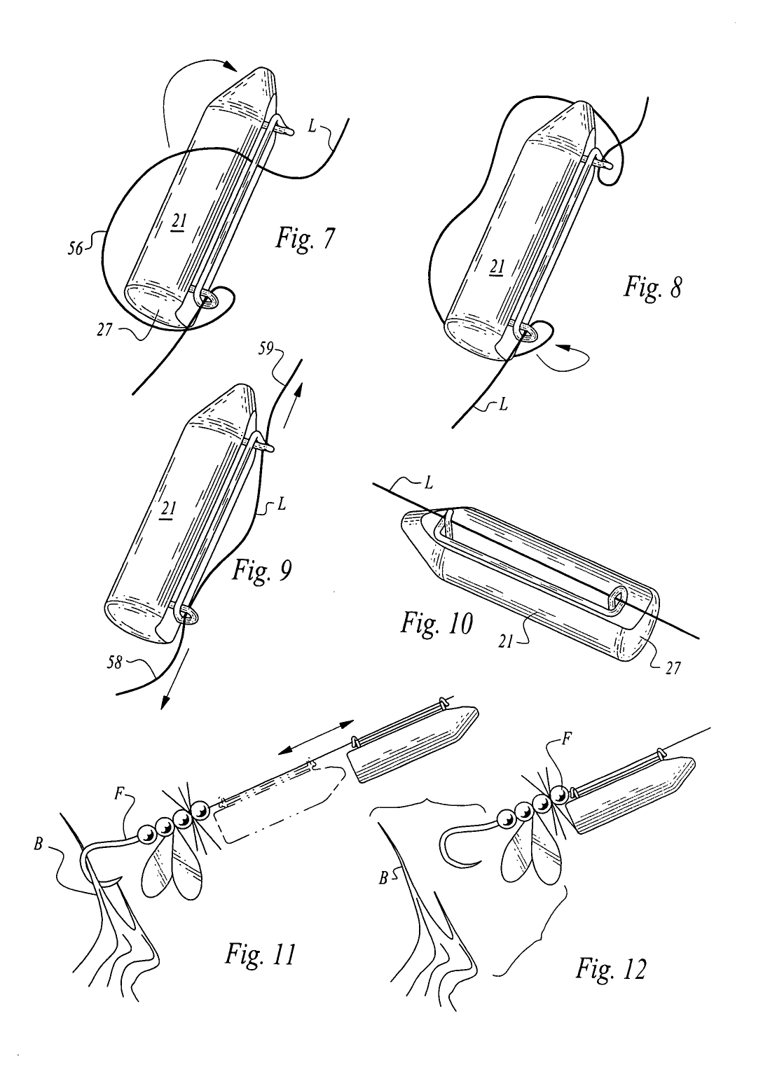

The next step, which is quickly accomplished, involves manipulating the curl 56 over one end of the retriever, e.g., the butt end 27 as seen in FIG. 7. Then, and coincidentally, coiling the curl 56 over the other end, in this instance the nose end 25, as seen in FIG. 8.

Having thus wrapped the curl beneath the crossbar and about the retriever, one need only pull the remote ends 58, 59 of the fishing line L [FIG. 9] taut, the result of which pulls the line L through the spaces 52, 54 and into the loops 45, 47 where the line is unimpeded, and the guide is free to move on the line L [FIG. 10].

Having now secured the retriever 21 for unrestricted movement along the line L and with the fishing line as close to vertical as reasonably possible, the retriever is released and will gravitationally descend to the lure, as seen in FIG. 11, where it impacts the lure to free it from the debris B.

Once the lure is freed, the retriever is easily removed, by reversing the steps which attached the guide to the line, and placed in the tackle box for future use either as a retriever or as a sinker.

Having read the description, some variation in the specific elements of the system will occur to those skilled in the art. Such variations are within the contemplation of the invention as described in the accompanying claims, wherein:

1. In a system for the retrieval of a fishing lure at the end of a fishing line snagged on subsurface debris, said system including a retriever;
said retriever being generally cylindrical in shape and having a nose end and a butt end;
a guide; said guide being affixed to said retriever, said guide having upstanding posts, a loop at the top of each post, said loops terminating at a cross bar extending there between; a space being formed between each said loop and said crossbar such that a fishing line is fitted through said spaces to said loops to thereby permit said guide to move freely along the said fishing line to impact the lure at the end thereof to thereby free the lure from debris.

2. The fishing lure retrieval system of claim 1, wherein said retriever is formed with a cylindrical body, said retriever having a pointed nose at one end and a butt end at the other, said retriever further having a longitudinally extending trough formed therein.

3. The fishing lure retrieval system of claim 2, wherein said guide is secured to said retriever in said trough.

4. The fishing lure retrieval system of claim 2, wherein said loops slant outwardly toward the ends of said retriever.

5. The fishing lure retrieval system of claim 2, wherein said retriever is so mounted to said fishing line so as to cause the butt end of said retriever to impact said lure as it moves along said fishing line.

6. A system for retrieving a lure at the end of a fish line where the lure is snagged on sub surface debris; wherein a retriever is provided for selective attachment to a fishing line so as to permit said retriever to move freely down the fishing line to impact a lure appended thereto, and where a guide is affixed to said retriever;
said guide comprising an unitary wire, said wire having remote ends affixed to said retriever, each of said ends forming an upstanding post, each of said posts terminating in a loop, each said loop terminating in a cross bar, said crossbar extending between said loops;
said guide being attached to said fishing line by forming a curl in said fishing line; passing said curl beneath said crossbar, manipulating said curl over the ends of said retriever, and pulling said fishing line taut, whereby said retriever is free to move along said fishing line unimpeded to said lure where it delivers a blow to said lure to free the same.

7. The lure retrieval system of claim 6, wherein a space is provided between said cross bar and said posts.

8. The lure retrieval system of claim 6, wherein said fishing line being pulled through said space and into said loops when said fishing line is pulled taut.

9. The lure retrieval system of claim 1, wherein said retriever is secured to said fishing line so as to serve as a sinker.

10. The method of securing a retriever to a fishing line in which said retriever includes a guide, said guide formed of a unitary wire, said wire having remote ends, said ends being secured in said retriever;
said wire defining a pair of upstanding posts, each said posts terminating in a loop, and said loops terminating in a cross bar;
the method comprising the steps of forming a curl in said fishing line;
passing said loop beneath said crossbar;
moving said curl about the ends of said retriever; and pulling said fishing line taut.

11. The lure retrieval system of claim 10, wherein a space is defined between each said post and said loop to which it is formed; said fishing line passing through said space such that said guide and said retriever attached thereto is movable freely on said fishing line.
